(19) United States
(12) Patent Application Publication
(10) Pub. No.: US 2003/0151697 A1
(43) Pub. Date: Aug. 14, 2003

(54) Apparatus for transmitting video signal, apparatus for receiving video signal, transceiver therefor, and method for determining channel

(75) Inventor: Yong-jun Lim, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/234,716

(22) Filed: Sep. 5, 2002

(30) Foreign Application Priority Data
Feb. 8, 2002 (KR) 2002-7438

(51) Int. Cl. H04N 5/38; H04N 5/40

(52) U.S. Cl. 348/723; 348/724

(57) ABSTRACT

A wireless transmitting and receiving apparatus for wirelessly transmitting a video signal to a remote display apparatus, a transceiver therefor, and a channel determining method for determining a channel to be used in transmitting and receiving a video signal between transmitting and receiving apparatuses are provided. The video signal transmitting apparatus comprises a super heterodyne-type transmitter which selects one of a plurality of channels, modulates a video signal to be transmitted, and provides the modulated signal to an antenna; and a frequency band and channel selector which controls a modulation and demodulation frequency of the transmitter. The apparatus enables wireless transmission and reception of a video signal between a video signal processing apparatus and a remote display apparatus.

### BACKGROUND OF THE INVENTION

1. Field of the Invention

The present invention relates to a wireless transmitting and receiving apparatus for wirelessly transmitting a video signal to a remote display apparatus, a transceiver therefor, and a channel determining method for determining a channel to be used in transmitting and receiving a video signal between transmitting and receiving apparatuses. The present application is based on Korean Patent Application No. 2002-7438, filed Feb. 8, 2002, which is incorporated herein by reference.

2. Description of the Related Art

In general, a video signal (video and audio signal) which is reproduced in a video player is watched through a television receiver or a monitor. For this, a wired transmission method in which a video player is connected to a television receiver or a monitor through wire is used conventionally.

Meanwhile, since most display apparatuses adopting new methods, such as plasma display panels (PDP) and liquid crystal displays (LCD), do not have an embedded function for receiving and decoding a signal, those apparatuses need a separate set top box (STB), and therefore need a wire for connecting the STB to the display apparatuses.

This wired transmission method deteriorates the appearance because of the exposed wire lines, and if the length of the wire is long, signal loss occurs to degrade reproducing picture quality.

In addition, considering a trend where most display apparatuses are moving to the PDP and LCD in the near future, solutions for the drawbacks of the wired method are in urgent need.

### SUMMARY OF THE INVENTION

To solve the above problems, it is a first objective of the present invention to provide a transmitting apparatus which can be conveniently connected, has a good appearance, and is appropriate to wireless transmission.

It is a second objective of the present invention to provide a receiving apparatus appropriate to the transmitting apparatus.

It is a third objective of the present invention to provide a super heterodyne-type transceiver appropriate to the transmitting apparatus and receiving apparatus.

It is a fourth objective of the present invention to provide a channel determining method appropriate to the transmitting apparatus and receiving apparatus.

To accomplish the first objective of the present invention, there is provided a video signal transmitting apparatus comprising a super heterodyne-type transmitter which selects one of a plurality of channels, modulates a video signal to be transmitted, and provides the modulated signal to an antenna; and a frequency band and channel selector which controls a modulation and demodulation frequency of the transmitter.

To accomplish the second objective of the present invention, there is provided a video signal receiving apparatus comprising a super heterodyne-type receiver which selects one of a plurality of channels and demodulates a video signal from a received signal input through an antenna; and a frequency band and channel selector which controls a modulation and demodulation frequency of the receiver.

To accomplish the third objective of the present invention, there is provided a super heterodyne-type transceiver which modulates a video signal to be transmitted and demodulates a video signal from a received signal, the transceiver comprising a duplexer filter which outputs a modulated video signal to the antenna, or receives a modulated video signal received by the antenna; a wide band pass filter which selects a frequency band for demodulating the modulated video signal provided by the duplexer filter; a demodulator which demodulates the video signal of the selected channel from a predetermined frequency band selected by the wide band pass filter; a modulator which modulates a video signal to be transmitted through a selected channel and provides the modulated signal to the duplexer filter; and a frequency synthesizer which sets the frequency of carriers provided to the modulator and demodulator according to the selected channel.

To accomplish the fourth objective of the present invention, there is provided a channel selection method which determines a channel to be used between a transmitting apparatus that selects one of a plurality of channels and transmits a video signal, and a receiving apparatus corresponding to the transmitting apparatus, the channel selection method comprising each of the transmitting apparatus and the receiving apparatus searching channels that are available; comparing available channels through a predetermined dedicated channel between the transmitting apparatus and the receiving apparatus, and selecting a channel to be used; the transmitting apparatus transmitting a pilot signal having a predetermined power through the selected channel; the receiving apparatus detecting the receiving power of the pilot signal, calculating an optimal transmission power needed in the transmitting apparatus, and transmitting the calculated optimal transmission power to the transmitting apparatus through the dedicated channel; and transmitting a video signal at the optimal transmission power through a channel selected by the receiving apparatus.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram showing the prior art wired transmission method;

FIG. 2 is a schematic diagram showing a wireless transmission method according to the present invention;

FIG. 3 is a block diagram showing a preferred embodiment of a transmitting and receiving apparatus according to the present invention;

FIG. 4 is a flowchart of a channel setting method of the present invention;

FIG. 5 is another embodiment of a flowchart showing a process for determining a channel to be used in a channel determining method according to the present invention;

FIG. 6 is a schematic diagram of an example of channel selection; and

FIG. 7 is a block diagram showing a detailed structure of a transceiver, a frequency band and channel detector, a frequency band and channel selector shown in FIG. 3.

### DESCRIPTION OF THE PREFERRED EMBODIMENTS

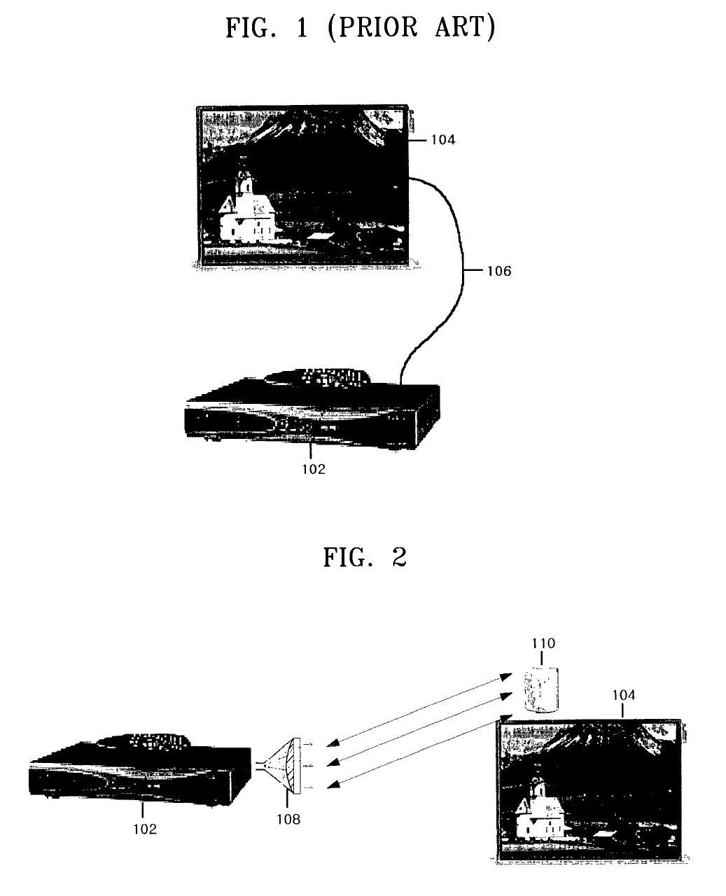

As shown in FIG. 1, according to the prior art wired transmission method, a video player 102 is connected to a display apparatus 104 through wire. An RCA cable, a super video (S-VIDEO) cable, or a digital video interface (DVI) cable may be used as the wire.

S-VIDEO cable transmits luminance Y and chrominance C, separately, and DVI cable transmits a digital signal.

Since the prior art wired transmission method as shown in FIG. 1 needs a wired line 106 which connects a video signal processing apparatus, such as a video player, to a display apparatus, the wired line 106 detracts from the appearance, and if the length of the line is long, the picture quality is degraded due to the transmission loss.

FIG. 2 is a schematic diagram showing a wireless transmission method according to the present invention.

As shown in FIG. 2, the video player 102 and the display apparatus 104 have respective antennas 108 and 110, with which needed signals are transmitted and received.

Therefore, since the wireless transmission method shown in FIG. 2 does not need a wired line for connecting the video player 102 and the display apparatus 104, the method in FIG. 2 can solve problems of the wired transmission method.

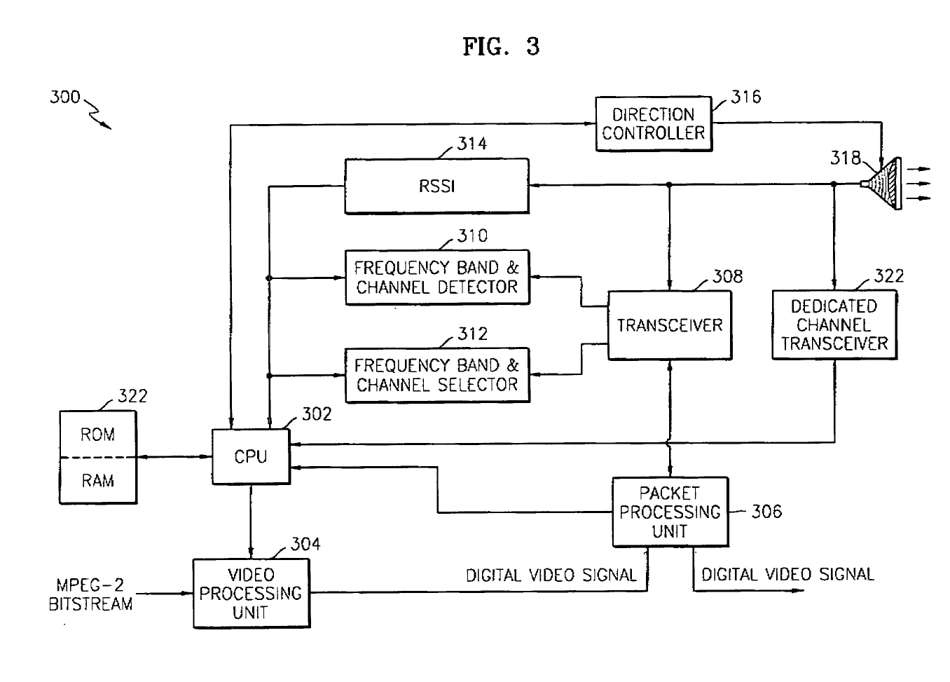

FIG. 3 is a block diagram showing a preferred embodiment of a transmitting and receiving apparatus according to the present invention. The transmitting and receiving apparatus 300 shown in FIG. 3 has a structure in which a transmitting apparatus and a receiving apparatus of the present invention are functionally combined.

The transmitting and receiving apparatus shown in FIG. 3 comprises a control unit 302, a packet processor 306, a transceiver 308, a frequency band and channel detector 310, a frequency band and channel selector 312, a received signal strength indicator 314, a direction controller 316, and an antenna 318. A memory 322 includes ROM and RAM. ROM stores program codes and permanent data, and RAM stores temporary data.

Here, the packet processor 306, the transceiver 308, the frequency band and channel selector 312, and the antenna relate to transmitting and receiving a video signal, and the receiving signal strength indicator 314, and the frequency band and channel detector 310 relate to channel selection.

Also, the packet processor 306 and the transceiver 308 correspond to the transmitting and receiving means in the abstract of the present invention, and if packet data processing is not required, the packet processor 306 can be omitted.

First, an operation for transmitting a video signal in the apparatus shown in FIG. 3 will now be explained.

The video processor 304 is a normal device, corresponding to an STB, a television receiver, and a video player, and outputs a digital video signal. Here, the digital video signal is obtained by converting an analog video signal into a digital signal by an analog-to-digital converter, and includes video and audio information.

In an STB, a video signal is demodulated from a bit stream which is input complying with MPEG-2 program stream/transport stream (PS/TS) specifications, and the demodulated signal is converted into a digital signal and output. In a television receiver, a video signal of a channel selected from a broadcast signal is demodulated, and the demodulated signal is converted into a digital signal and output. In a video player, a video signal reproduced from a tape is converted into a digital signal and output.

Though a digital video signal is transmitted in a preferred embodiment of the present invention, it is clear to a person in the art that a bit stream complying with MPEG-2 PS/TS specifications can be transmitted within the scope of the present invention.

The packet processor 306 converts a digital video signal provided from the video processor 304 into packet data or datagram that can be transmitted and received in the OSI 7 layer model. In particular, the packet processor 306 process data link in the local link control (LLC) & MAC layer. Here, the LLC is an upper part of the data link layer and is defined in IEEE 802.2. The LLC sub-layer provides a predetermined interface of a normal network layer to users and the lower part of the LLC is an MAC sub-layer.

A digital video signal is packetized in the packet processor 306, and header information indicating the type of data (video/audio), destination, and the like is added to each packet.

The transceiver 308 modulates packet data output from the packet processor 306 with a carrier determined by the frequency band and channel selector 312, and outputs the modulated data.

The modulated signal output from the transceiver 308 is transmitted through the antenna 318. The antenna 318 is a directional antenna, and its direction is controlled by the direction controller 316.

An operation for receiving a video signal in the apparatus shown in FIG. 3 will now be explained.

A receiving signal which is received through the antenna 318 is restored to packet data in the transceiver 308.

The packet processor 306 restores a digital video signal from the packet data provided from the transceiver 308, and outputs the digital video signal. The digital video signal is displayed through a display apparatus, such as a PDP, an LCD, or a CRT.

Since the apparatus shown in FIG. 3 transmits and receives a video signal using a plurality of channels, a frequency band and channel to be used in transmitting a video signal from a predetermined transmitting apparatus should be able to be determined, and in particular, an optimal transmission sensitivity in a channel to be used should be able to be determined.

An operation for determining a channel in the apparatus shown in FIG. 3 will now be explained.

A signal received by the antenna 318 is provided to the transceiver 308, and the frequency band and channel detector 310 detects a frequency band and channel used in the signal and provides it to the control unit 302.

The receiving signal strength indicator 314 detects the receiving strength of a pilot signal from the received signal and provides it to the control unit 302.

The control unit 302 determines a channel to be used, referring to used channels detected by the frequency band and channel detector 310, and determines an optimal transmission sensitivity in the selected channel, referring to the receiving sensitivity of the pilot signal detected by the receiving signal strength indicator 314.

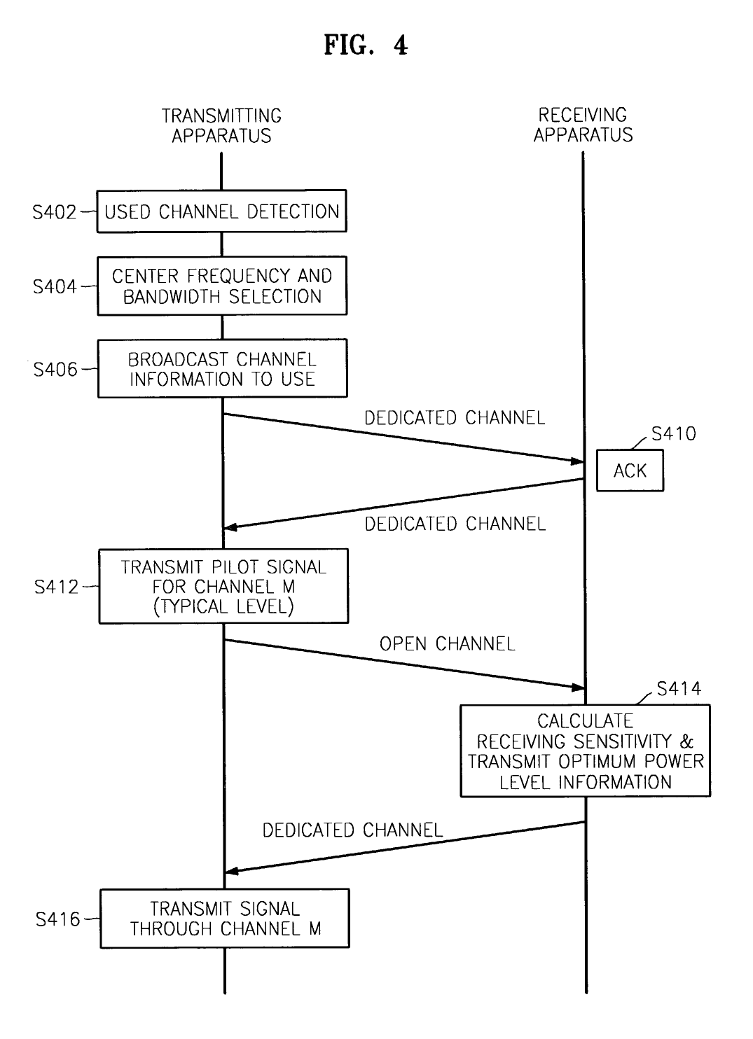

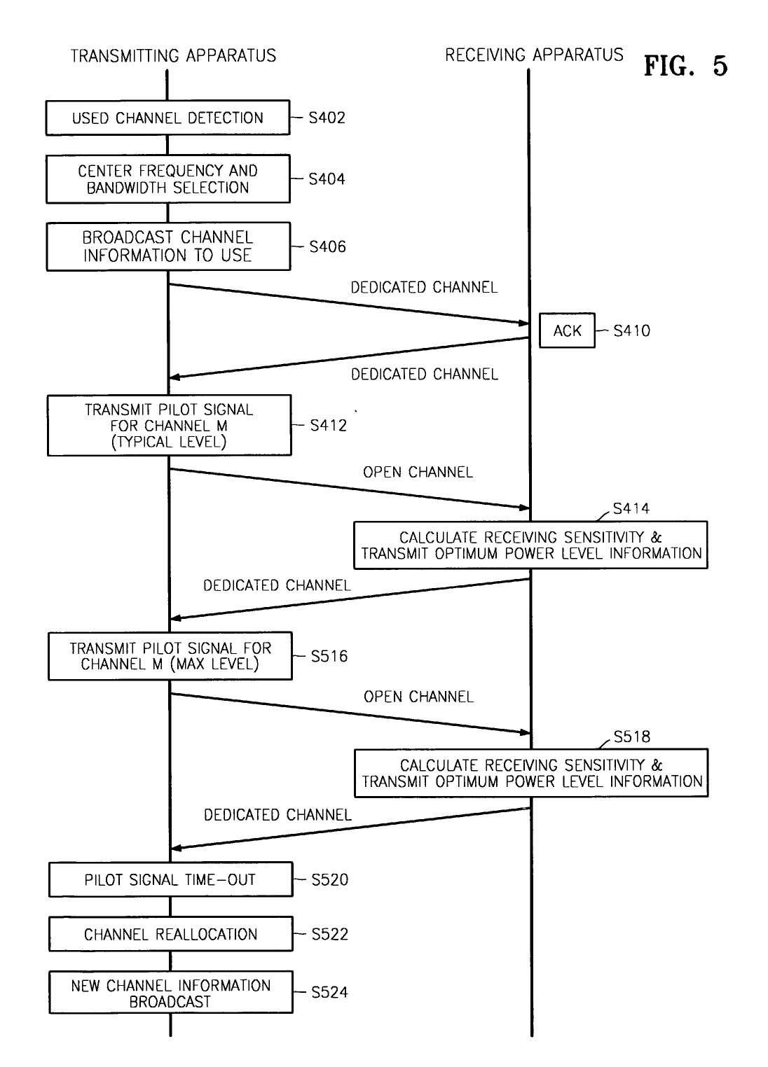

FIG. 4 is a flowchart of a channel setting method of the present invention.

The apparatus shown in FIG. 3 is installed in a transmitting side which transmits a video signal and in a receiving side which receives the video signal. Before transmitting a video signal, the apparatus installed in the transmitting side (hereinafter, referred to as a “transmitting apparatus”) and the apparatus installed in the receiving side (hereinafter, referred to as a “receiving apparatus”) communicates signals in order to determine a channel to be used. The communications are performed through a dedicated channel, where data are exchanged at a relatively lower bit rate.

Here, the dedicated channel is one of channels that can be used by the transmitting apparatus and receiving apparatus, and is commonly used by the transmitting apparatus and receiving apparatus.

As a result of the communications, a channel to be used, that is, a frequency band to be used, is determined. When there is a request for transmission, the control units 302 of the transmitting apparatus and the receiving apparatus perform the steps shown in FIG. 4 to determine a transmission channel.

First, the transmitting apparatus detects a used channel in step S402. The used channel is detected by the frequency band and channel detector 310 or is indicated by the control unit 302. For example, the control unit 302 keeps the history of channel usage, and referring to this information, a used channel can be found.

The control unit 302 determines a channel to be used among channels that are not in use in step S404. It is assumed that a central frequency and bandwidth of each channel is already known.

The transmitting apparatus broadcasts information related to a channel to be used, for example, a channel number, or a central frequency and bandwidth, through a dedicated channel in step S406. Information related to a channel to be used is received by the receiving apparatus. The dedicated channel transceiver 322 shown in FIG. 3 processes data communications through the dedicated channel.

If the receiving apparatus receives information related to a channel to be used, it is determined whether or not the channel can be used, by comparing used channels as in the transmitting apparatus.

A used channel is detected by the frequency band and channel detector 310 of the receiving apparatus or is indicated by the control unit 302 of the receiving apparatus.

If the channel can be used, the receiving apparatus broadcasts an acknowledging signal ACK through the dedicated channel in step S410.

If the transmitting apparatus receives the acknowledging signal ACK, a temporary agreement on the channel to be used between the transmitting apparatus and the receiving apparatus is made. Then, through the agreed channel, a pilot signal is communicated so that a transmission power to be transmitted from the transmitting apparatus is determined.

If the transmitting apparatus receives the acknowledging signal ACK, the transmitting apparatus transmits a pilot signal through the channel to be used in step S412. The pilot signal has a predetermined power.

If the receiving apparatus receives the pilot signal, the receiving apparatus determines the receiving strength of the signal, determines an optimal transmitting power corresponding to the determined strength, and transmits the determined optimal transmitting power to the transmitting apparatus through the dedicated channel in step S414. Though the transmitting apparatus transmits the pilot signal in a predetermined power, the power of the pilot signal received by the receiving apparatus is different from the power of the pilot signal when it is broadcast. That is, due to the environment of a transmission route, and interference of other wireless signals, the power of the pilot signal received by the receiving apparatus becomes weaker than the power of the pilot signal when it is broadcast by the transmitting apparatus, and in the worst case, the signal is too weak to receive.

The receiving apparatus detects the difference between a preferable receiving power and an actual receiving power of the pilot signal, and calculates a transmitting power needed in compensating for the difference, that is, an optimal transmitting power required when the transmitting apparatus transmits the pilot signal.

If the transmitting apparatus receives the optimal transmitting power transmitted by the receiving apparatus, the transmitting apparatus transmits a video signal through the selected channel at the optimal transmitting power in step S416.

The transmitting apparatus may not receive a response on the pilot signal from the receiving apparatus, and an operation for this will now be explained referring to FIG. 5.

FIG. 5 is a flowchart of another embodiment showing a process for determining a channel to be used in a channel determining method according to the present invention, and shows a case where the receiving apparatus cannot receive a pilot signal through the selected channel.

Steps S402 through S414 in FIG. 5 are the same as those of FIG. 4.

If the receiving apparatus cannot receive a pilot signal, the receiving apparatus cannot broadcast an optimal transmitting power to the transmitting apparatus, and therefore step S416 of FIG. 4 cannot be performed.

For this, the transmitting apparatus waits for a response from the receiving apparatus for a predetermined time, and if there is no response during the time, the transmitting apparatus transmits a pilot signal at a maximum power (MAX level) in step S516.

The receiving apparatus detects the difference between a preferable receiving power and an actual receiving power of the pilot signal, calculates a transmitting power needed in compensating for the difference, that is, an optimal transmitting power required when the transmitting apparatus transmits the pilot signal, and broadcasts the calculated power to the transmitting apparatus in step S518.

After step S516, the transmitting apparatus again waits for a response from the receiving apparatus for a predetermined time, and if there is no response again during the time, that is, if pilot signal time-out occurs in step S520, the transmitting apparatus reallocates a channel through the selected channel in step S522. That is, the transmitting apparatus communicates with the receiving apparatus through the dedicated channel to reallocate a new channel.

A pilot signal is transmitted through the reallocated channel in step S520.

By repeatedly performing this process for usable channel, a channel to be used is established.

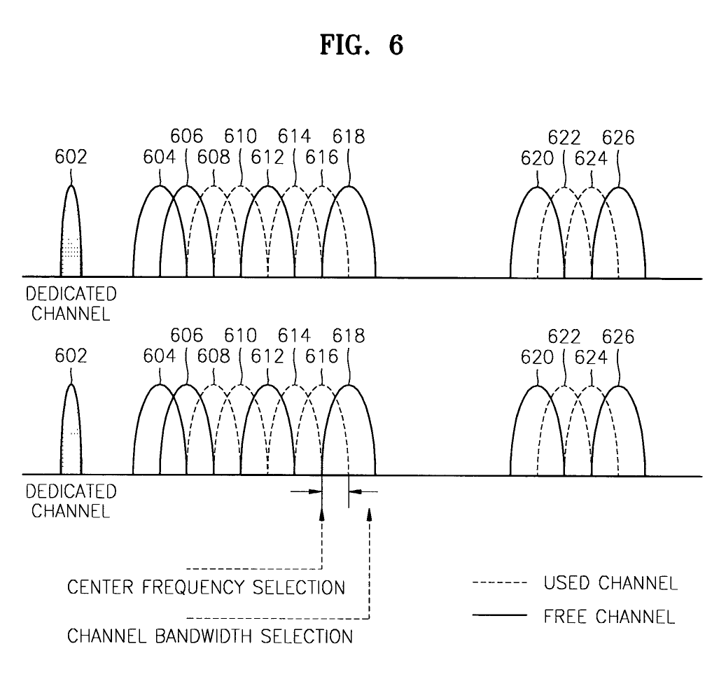

FIG. 6 is a schematic diagram of an example of channel selection. In FIG. 6, 602 indicates the dedicated channel, 604-618 indicate first frequency band channels, and 620-626 indicate second frequency band channels.

The transmitting apparatus and receiving apparatus communicate information to determine channel allocation and an optimal transmitting power through the dedicated channel 602.

The transmitting apparatus and receiving apparatus detect used channels, and determines one of channels not in use, that is, a central frequency and bandwidth.

As a result of the communications between the transmitting apparatus and receiving apparatus, a channel 616 having a predetermined central frequency and bandwidth as shown at the bottom of FIG. 6 is allocated for transmission of a video signal.

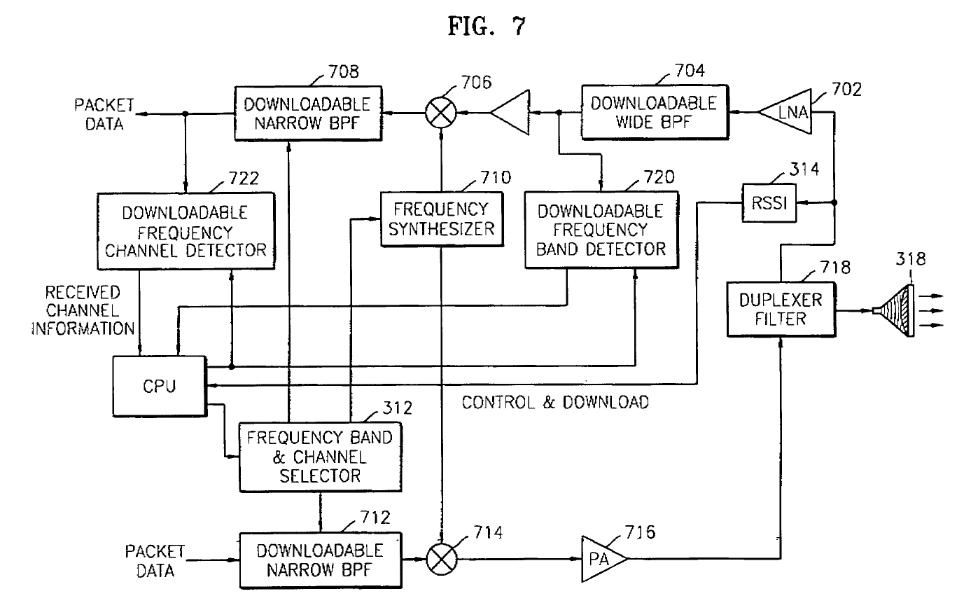

FIG. 7 is a block diagram showing a detailed structure of a super heterodyne-type transceiver, a frequency band and channel detector, a frequency band and channel selector shown in FIG. 3. The transceiver shown in FIG. 7 corresponds to the transmitting apparatus and receiving apparatus in the abstract of the present invention, and a function combination of the transmitting apparatus and receiving apparatus.

The transceiver shown in FIG. 7 comprises a low noise amplifier (LNA) 702, a wide band pass filter (Wide BFP) 704, a demodulator 706, a narrow band pass filter (Narrow BPF) 708, a frequency synthesizer 710, a band pass filter 712, a modulator 714, a power amplifier 716, and a duplexer filter 718.

The downloadable frequency band detector 720 and the downloadable frequency channel detector 722 of FIG. 7 correspond to the frequency band and channel detector 310 shown in FIG. 3.

The frequency band detector 720 and the channel detector 722 have downloadable structures, whose functions can be changed by changing execution codes.

A video signal received by the antenna 318 is demodulated through the duplexer filter 718, the wide BPF 704, the demodulator 706, and the narrow BPF 708, and provided to the packet processor 306.

Meanwhile, packet data provided from the packet processor 306 is transmitted through the band pass filter 712, the modulator 714, the duplexer filter 718, and the antenna 318.

In the present invention as shown in FIG. 7, by adopting a super heterodyne-type transceiver into which a modulator and a demodulator are combined, the structure of the transceiver can be simplified.

As described above, the transmitting and receiving apparatus according to the present invention enables to wirelessly transmit and receive a video signal between a video signal processing apparatus and a remote display apparatus.

Also, the channel determining method according to the present invention enables to determine a channel and an optimal transmitting power to be used between a transmitting apparatus and a receiving apparatus so that optimal transmitting and receiving data excluding interference is provided.

What is claimed is:

1. A video signal transmitting apparatus comprising:
a super heterodyne-type transmitter which selects one of a plurality of channels, modulates a video signal to be transmitted, and provides the modulated signal to an antenna; and
a frequency band and channel selector which controls a modulation and demodulation frequency of the transmitter.

2. The apparatus of claim 1, further comprising:
a frequency band and channel detector which detects a used channel from a receiving signal in an operational combination with the frequency band and channel selector;
a dedicated channel transceiver which transmits and receives data with other transmitting and receiving apparatus through a predetermined dedicated channel; and
a control unit which controls the transmitting apparatus such that if there is a request for transmitting a video signal, a used channel is detected by the frequency band and channel detector; by communicating with a receiving apparatus through the dedicated channel transceiver, a channel to be used between the transmitting apparatus and the receiving apparatus is selected; through the selected channel, a pilot signal having a predetermined power is transmitted to the receiving apparatus; and according to an optimal transmission power transmitted by the receiving apparatus and received through the dedicated channel transceiver, a video signal is transmitted through the selected channel.

3. The apparatus of claim 1, wherein the antenna is a directional antenna, and further comprising a direction controller which controls the direction of the directional antenna.

4. The apparatus of claim 1, wherein the super heterodyne-type transmitter comprises:
a duplexer filter which outputs the modulated video signal to the antenna;
a modulator which modulates the video signal to be transmitted to the duplexer filter; and
a frequency synthesizer which sets the frequency of carriers provided to the modulator according to the control of the frequency band and channel selector.

5. A video signal receiving apparatus comprising:
a super heterodyne-type receiver which selects one of a plurality of channels and demodulates a video signal from a received signal input through an antenna; and
a frequency band and channel selector which controls a modulation and demodulation frequency of the receiver.

6. The apparatus of claim 5, further comprising:
a frequency band and channel detector which detects a used channel from a receiving signal in an operational combination with the frequency band and channel selector;
a dedicated channel transceiver which transmits and receives data with a transmitting apparatus through a predetermined dedicated channel;
a receiving signal strength detector which detects the power of a pilot signal transmitted through a channel selected by the transmitting apparatus and receiving apparatus; and
a control unit which controls the receiving apparatus such that if there is a request for transmitting a video signal, the used channel is detected by the frequency band and channel detector; through the dedicated channel transceiver, a channel to be used between a transmitting apparatus and the receiving apparatus is selected; and an optimal transmitting power corresponding to the power of the pilot signal detected by the receiving signal strength detector is provided to the transmitting apparatus through the dedicated channel transceiver.

7. The apparatus of claim 5, wherein the antenna is a directional antenna, and further comprising a direction controller which controls the direction of the directional antenna.

8. The apparatus of claim 5, wherein the super heterodyne-type receiver comprises:
a duplexer filter which receives a modulated video signal received by the antenna;
a wide band pass filter which selects a frequency band for demodulating the modulated video signal provided by the duplexer filter;
a demodulator which demodulates the video signal of the selected channel from a predetermined frequency band selected by the wide band pass filter; and
a frequency synthesizer which sets the frequency of carriers provided to the demodulator according to the control of the frequency band and channel selector.

9. A video signal transmitting and receiving apparatus comprising:
a super heterodyne-type transmitter and receiver which selects one of a plurality of channels, modulates a video signal to be transmitted, and provides the modulated signal to an antenna, or demodulates a video signal from a received signal input through the antenna; and
a frequency band and channel selector which controls a modulation and demodulation frequency of the transmitter and receiver.

10. The apparatus of claim 9, further comprising:
a receiving signal strength detector which detects the power of a pilot signal transmitted through a channel selected by the transmitting apparatus and receiving apparatus;
a frequency band and channel detector which detects a used channel from a receiving signal in an operational combination with the frequency band and channel selector;
a dedicated channel transceiver which transmits and receives data with other transmitting and receiving apparatus through a predetermined dedicated channel; and
a control unit which controls the transmitting and receiving apparatus such that if there is a request for transmitting a video signal, the used channel is detected by the frequency band and channel detector; through the dedicated channel transceiver, a channel to be used between a transmitting apparatus and a receiving apparatus is selected; through the selected channel, a pilot signal having a predetermined power is transmitted to the receiving apparatus, or through the dedicated channel transceiver, an optimal transmission power corresponding to the receiving power of the pilot signal detected by the receiving signal strength detector is provided to the transmitting apparatus; and a video signal is transmitted through a channel selected according to the optimal transmission power.

11. The apparatus of claim 9, wherein the antenna is a directional antenna, and further comprising a direction controller which controls the direction of the directional antenna.

12. The apparatus of claim 9, wherein the super heterodyne-type transceiver and receiver comprises:
a duplexer filter which outputs a modulated video signal to the antenna, or receives a modulated video signal received by the antenna;
a wide band pass filter which selects a frequency band for demodulating the modulated video signal provided by the duplexer filter;
a demodulator which demodulates the video signal of the selected channel from a predetermined frequency band selected by the wide band pass filter;
a modulator which modulates a video signal to be transmitted through a selected channel and provides the modulated signal to the duplexer filter; and
a frequency synthesizer which sets the frequency of carriers provided to the modulator and demodulator according to the selected channel.

13. A super heterodyne-type transceiver which modulates a video signal to be transmitted and demodulates a video signal from a received signal, the transceiver comprising:
a duplexer filter which outputs a modulated video signal to the antenna, or receives a modulated video signal received by the antenna;
a wide band pass filter which selects a frequency band for demodulating the modulated video signal provided by the duplexer filter;
a demodulator which demodulates the video signal of the selected channel from a predetermined frequency band selected by the wide band pass filter;
a modulator which modulates a video signal to be transmitted through a selected channel and provides the modulated signal to the duplexer filter; and
a frequency synthesizer which sets the frequency of carriers provided to the modulator and demodulator according to the selected channel.

14. The transceiver of claim 13, further comprising:
a narrow band pass filter which band pass filters a video signal of a predetermined channel demodulated by the demodulator, according to the bandwidth of the selected channel.

15. The transceiver of claim 13, further comprising:
a narrow band pass filter which band pass filters a video signal to be transmitted, according to the bandwidth of the selected channel.

16. A channel selection method which determines a channel to be used between a transmitting apparatus that selects one of a plurality of channels and transmits a video signal, and a receiving apparatus corresponding to the transmitting apparatus, the channel selection method comprising:
each of the transmitting apparatus and the receiving apparatus searching channels that are available;
comparing available channels through a predetermined dedicated channel between the transmitting apparatus and the receiving apparatus, and selecting a channel to be used;
the transmitting apparatus transmitting a pilot signal having a predetermined power through the selected channel;
the receiving apparatus detecting the receiving power of the pilot signal, calculating an optimal transmission power needed in the transmitting apparatus, and transmitting the calculated optimal transmission power to the transmitting apparatus through the dedicated channel; and
transmitting a video signal at the optimal transmission power through a channel selected by the receiving apparatus.

17. The method of claim 16, further comprising:
the transmitting apparatus waiting for a response from the receiving apparatus for a first predetermined time after transmitting the pilot signal having a predetermined power; and
if there is no response in the waiting step, transmitting a pilot signal having a maximum power.

18. The method of claim 17, further comprising:
a channel reallocation step for waiting again for a second predetermined time after transmitting the pilot signal having a maximum power, and if there is no response again, selecting a new channel through the dedicated channel.
